(19) United States
(12) Patent Application Publication
(10) Pub. No.: US 2024/0305469 A1
(43) Pub. Date: Sep. 12, 2024

(54) APPARATUS AND METHOD FOR PROVIDING SERVICE OF ISSUING MEDIA CONTENT TOKEN BASED ON BLOCKCHAIN

(71) Applicant: ARTIFRIENDS INC., Seongnam-si, Gyeonggi-do (KR)

(72) Inventor: Jung Woo LEE, Daejeon (KR)

(73) Assignee: ARTIFRIENDS INC., Seongnam-si, Gyeonggi-do (KR)

(21) Appl. No.: 18/574,493

(22) PCT Filed: Feb. 15, 2022
(86) PCT No.: PCT/KR2022/002246

§ 371 Date: Dec. 27, 2023

(30) Foreign Application Priority Data
Jun. 30, 2021 (KR) 10-2021-0085986
Oct. 18, 2021 (KR) 10-2021-0138643

(51) Int. Cl. H04L 9/32; G06Q 20/38; H04L 9/00

(52) U.S. Cl. CPC H04L 9/3247; G06Q 20/3825; H04L 9/50

(57) ABSTRACT

Provided are an apparatus and a method for providing a service of issuing a media content token based on a blockchain, wherein the apparatus includes: an application installed in a user terminal, and configured to generate media content data, receive a user contract template corresponding to the media content data from a template factory server, generate a media content token, add an electronic signature to the media content token, and issue the media content token to which the electronic signature is added, to a blockchain network; and the template factory server configured to generate the user contract template corresponding to the media content data on the basis of a pre-stored standard contract template.

### TECHNICAL FIELD

The present disclosure relates to an apparatus and a method for providing a service of issuing a media content token based on a blockchain. More particularly, the present disclosure relates to an apparatus and a method for providing a service of issuing a media content token based on a blockchain, the apparatus and the method being capable of issuing a copyright on media content data generated through a user terminal, to a blockchain network in the form of a non-fungible token (NFT) in real time.

### BACKGROUND ART

In general, a blockchain means a management technology in which continuously increasing data is recorded in blocks of particular units and nodes constituting a peer-to-peer (P2P) network manage the blocks in a chain-type data structure, or means the data itself constructed in a chain-type data structure. Herein, the blockchain constructed in chain-type data structure is operated in the form of a distributed ledger at each node without a central system.

Each of the nodes constituting the blockchain network manages the blocks in a chain-type data structure. In each block, a hash value for the previous block is recorded, and the previous block may be referenced through the hash value. Accordingly, as the blocks are accumulated, it is difficult to forge or falsify the data recorded in the blocks, the reliability of the data is improved, and the integrity of the data is ensured even in a distributed environment.

A non-fungible token (NFT) is a technology that uses blockchain network characteristics to create an electronic token non-replicable and uniquely recognized. Electronic tokens contain a name, owner, and meta data information. Herein, owner information is written in the form of a wallet address. In order to transmit an electronic token or exercise the right to burning or splitting, it is necessary to present an electronic signature that can prove owner information, that is, a wallet address. Therefore, only the person who presents the electronic signature based on the blockchain network can exercise the right of the electronic token.

In order to issue and manage non-fungible tokens (NFTs), a blockchain technology equipped with a smart contract function is required. The smart contract is a technology in which the program code defining procedure and authority is stored in a blockchain network to abstractly implement a non-forgeable or non-falsifiable fair procedure. Therefore, a complex procedure is required to implement the smart contracts for expressing non-fungible tokens (NFTs) and to describe the transaction data corresponding thereto. In general, non-fungible tokens (NFTs) are issued by writing a program code manually and attaching an electronic signature to register in the blockchain network as a manual procedure, or by entrusting transaction creation to a third party. These methods take a long time to issue non-fungible tokens (NFTs).

Because of this, when media content data is produced and a non-fungible token (NFT) is issued, there is a difference between the production time of the media content data and the issuance time of the non-fungible token (NFT). Thus, reproduction or secondary uses without notice may occur, and it may be difficult to determine whether there is a relationship of the right to the copyright.

### DISCLOSURE

### Technical Problem

Embodiments of the present disclosure are directed to providing an apparatus and a method for providing a service of issuing a media content token based on a blockchain, the apparatus and the method being capable of issuing the copyright on media content data generated through a user terminal, to a blockchain network in the form of a non-fungible token (NFT) in real time.

### Technical Solution

According to an embodiment, there is provided an apparatus for providing a service of issuing a media content token, the apparatus including: an application installed in a user terminal, and configured to generate media content data, receive a user contract template corresponding to the media content data from a template factory server, generate a media content token, add an electronic signature to the media content token, and issue the media content token to which the electronic signature is added, to a blockchain network; and the template factory server configured to generate the user contract template corresponding to the media content data on the basis of a pre-stored standard contract template.

Herein, the application may include: a media content generation module configured to generate the media content data; a transaction module configured to receive the user contract template from the template factory server and generate a transaction that defines the media content token; an authentication module configured to verify the transaction to generate the electronic signature; and a network request module configured to issue a transaction to which the electronic signature is attached, to the blockchain network.

Herein, the media content generation module may be configured to execute a camera or a recorder to generate at least one selected from a group of image data, video data, and audio data, as the media content data.

Herein, the transaction module may be configured to transmit a contract generation request corresponding to a format of the media content data to the template factory server when the media content data is generated, and write the user contract template provided by the contract generation request to generate the transaction.

Herein, the one or more standard contract templates according to the formats of the media content data may be pre-stored in the template factory server, and the template factory server may be configured to select any one of the standard contract templates according to the contract generation request, and change the selected standard contract template according to a preset interface rule to generate the user contract template.

Herein, the interface rule may be a rule for selecting at least one piece of meta data of the media content data.

Herein, the authentication module may be configured to verify the transaction by using a private key.

In addition, the application may further include a preprocessing module configured to perform preprocessing on the media content data into a preset data structure.

Herein, the preprocessing module may be configured to perform preprocessing on the media content data into a preset capacity and a preset extension.

According to an embodiment, there is provided a method for providing a service of issuing a media content token, the method including: generating, by an application, media content data; generating, on the basis of a pre-stored standard contract template by a template factory server, a user contract template corresponding to the media content data; and receiving, by the application, the user contract template, generating a media content token, adding an electronic signature to the media content token, and issuing the media content token to which the electronic signature is added, to a blockchain network.

Herein, the generating of the media content data may include executing, by a media content generation module, a camera or a recorder to generate at least one selected from a group of image data, video data, and audio data, as the media content data.

Herein, the generating of the user contract template may include: storing the one or more standard contract templates according to the formats of the media content data; selecting any one corresponding to the format of the media content data generated by the application among the stored one or more standard contract templates; and changing the selected standard contract template according to a preset interface rule.

Herein, the interface rule may be a rule for selecting at least one piece of meta data of the media content data.

Herein, the issuing of the media content token may include: writing, by a transaction module, the user contract template to generate a transaction that defines the media content token; verifying, by an authentication module, the transaction to generate the electronic signature; and registering and storing, by a network request module, a transaction to which the electronic signature is added, in the blockchain network.

In addition, the method may further include performing, by a preprocessing module, preprocessing on the generated media content data into a preset data structure.

Herein, the performing of the preprocessing may include changing the generated media content data into a preset capacity and a preset extension

### Advantageous Effects

The disclosed technology may have the following effect. However, it does not mean that a particular embodiment should include the effect or only the effect. Therefore, the scope of the disclosed technology should not be understood as being limited thereby.

The apparatus and the method for providing the service of issuing the media content token based on the blockchain according to the embodiments of the present disclosure can issue the copyright on the media content data generated through the user terminal, to the blockchain network in the form of a non-fungible token (NFT) in real time.

### DESCRIPTION OF DRAWINGS

The above and other objectives, features, and other advantages of the present disclosure will be more clearly understood from the following detailed description when taken in conjunction with the accompanying drawings, in which:

FIG. 1 is a diagram illustrating a system for providing a service of issuing a media content token according to an embodiment of the present disclosure;

FIG. 2 is a block diagram illustrating a detailed configuration of an application shown in FIG. 1;

FIG. 3 is a block diagram illustrating a detailed configuration of an authentication module shown in FIG. 2;

FIG. 4 is a block diagram illustrating a detailed configuration of a template factory server shown in FIG. 1;

FIG. 5 is a diagram illustrating a method for providing a service of issuing a media content token according to an embodiment of the present disclosure; and

FIG. 6 is a diagram illustrating a configuration of a user contract template according to an embodiment of the present disclosure.

### MODE FOR INVENTION

A description in the present disclosure is merely an embodiment for structural or functional description, so the scope of the present disclosure should not be construed as being limited to the embodiments described herein. That is, since the embodiments may be modified in various ways and may be implemented in several forms, it should also be understood that the scope of the present disclosure includes equivalents that can realize the technical idea. In addition, the objective or effect disclosed in the present disclosure does not mean that a particular embodiment should achieve the objective or effect or should achieve only the effect. Therefore, it should not be understood that the scope of the present disclosure is limited thereby.

In the meantime, the meanings of the terms described in the present disclosure should be understood as follows.

Terms “first”, “second”, etc. are only used to distinguish one element from another element, and the scope of the present disclosure should not be limited by these terms. For example, a “first” element may be named a “second” element, and similarly, a “second” element may also be named a “first” element.

It will be understood that when an element is referred to as being “connected” to another element, it can be directly connected to the other element or intervening elements may be present therebetween. In contrast, it should be understood that when an element is referred to as being “directly connected” to another element, there are no intervening elements present. Meanwhile, other expressions describing relationships between elements, such as “between” and “immediately between”, or “adjacent to” and “directly adjacent to”, may be construed similarly.

The singular forms “a”, “an”, and “the” are intended to include the plural forms as well, unless the context clearly indicates otherwise. It is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

In steps, identification marks (for example, a, b, c, etc.) are used for convenience of description and do not describe the order of the steps. Unless explicitly described in a particular order in the context, the steps may be performed in a different order from the specified order. That is, the steps may be performed in the same order as specified, may be performed substantially simultaneously, or may be performed in the reverse order.

The present disclosure may be implemented as computer-readable code on a computer-readable recording medium. The computer-readable recording medium may include any type of recording device on which data readable by a computer system is stored. Examples of the computer-readable recording medium may include ROM, RAM, CD-ROM, a magnetic tape, a floppy disk, an optical data storage device, etc. In addition, the computer-readable recording medium may be distributed among networked computer systems so that computer-readable code can be stored and executed in a de-centralized manner.

Unless otherwise defined, all terms used herein have the same meaning as commonly understood by those skilled in the art to which the present disclosure pertains. It will be further understood that terms used herein should be interpreted as having a meaning that is consistent with their meaning in the context of this specification and the relevant art and will not be interpreted in an idealized or overly formal sense unless expressly so defined herein.

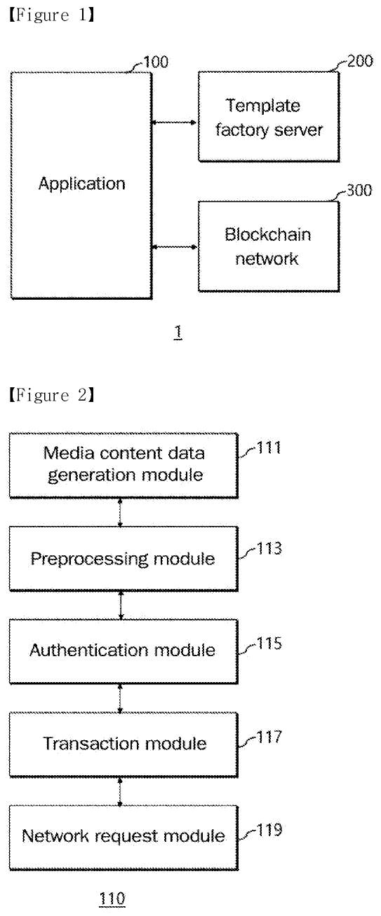

FIG. 1 is a diagram illustrating a system for providing a service of issuing a media content token according to an embodiment of the present disclosure.

Referring to FIG. 1, according to the embodiment of the present disclosure, the system 1 for providing a service of issuing a media content token may include a user terminal 100, a template factory server 200, and a blockchain network 300. The user terminal 100 may be a computing device used by a user who produces media content data. For example, the user terminal 100 may be a computing device, such as a smartphone, a tablet PC, a desktop PC, or a laptop PC, but is not limited thereto. The user terminal 100 may transmit data to and receive data from the template factory server 200 or the blockchain network 300 through a web-based communication protocol, for example, an HTTP protocol.

In the user terminal 100, an application 110 may be installed in an executable form, and the application 110 is capable of generating media content data and providing a service of issuing a token of the generated media content. The application 110 may receive user information and a user command through the user terminal 100, and may output a result of tasks performed through the application 110. Herein, the user information may include a name, an address, an e-mail address, a phone number, and an electronic wallet address.

The application 110 may execute a function of a camera or a recorder installed in the user terminal 100 to generate media content data. Herein, the media content data may include at least one selected from a group of image data, video data, and audio data.

The application 110 may automatically writes the copyright on the media content data of the user who has produced the media content data, in the form of a non-fungible token (NFT) (hereinafter, referred to as a media content token) and may perform issuance to the blockchain network 300 in real time.

Specifically, the application 110 may receive a user contract template corresponding to the media content data through the template factory server 200, may automatically write a transaction defining the media content token, may attach the electronic signature of the user who has produced the media content data to the written transaction, and may perform issuance to the blockchain network 300 in real time.

The template factory server 200 automatically generates, on the basis of a pre-stored standard contract template, a user contract template corresponding to the media content data generated through the application 110, and provides the user contract template to the application 110. Herein, the standard contract template is a basic code of a program code initially written by a professional developer, and when a new type of program code is required, a new standard contract template is written and is additionally stored in the template factory server 200.

The blockchain network 300 may include a plurality of nodes (not shown) connected in a peer-to-peer (P2P) manner over a network. Examples of the network may include wired/wireless communication networks including a TCP/IP communication network. Herein, the wireless communication networks may be communication networks such as Global System for Mobile Communication (GSM), Enhanced Data GSM Environment (EDGE), wideband code-division multiple access (WCDMA), code-division multiple access (CDMA), and time-division multiple access (TDMA), but are not limited thereto. The media content token issued to the blockchain network 300 may be propagated to the plurality of nodes and may be transacted. In the blockchain network 300, electronic wallets respectively corresponding to the plurality of nodes are registered, and a fee required for issuance and transaction of a media content token may be earmarked.

FIG. 2 is a block diagram illustrating a detailed configuration of the application shown in FIG. 1.

Referring to FIG. 2, the application 110 may include a media content generation module 111, a preprocessing module 113, a transaction module 115, a decentralized identifier (DID) module 117, and a network request module 119. The media content generation module 111 executes the function of the camera or the recorder of the user terminal 100 to generate media content data. Herein, the media content data may include at least one selected from a group of image data, video data, and audio data.

The preprocessing module 113 performs preprocessing on the media content data and transmits a result of preprocessing to the transaction module 117. Herein, the preprocessing module 113 may perform preprocessing on the media content data into a preset data structure. For example, when the capacity of media content data is greater than a preset capacity, the preprocessing module 113 splits the media content data into a plurality of pieces. In addition, when the extension of media content data does not correspond to preset types of extensions, the preprocessing module 113 converts the extension of the media content data into any one of the present types of extensions.

The transaction module 115 receives the media content data subjected to preprocessing through the preprocessing module 113, receives a user contract template corresponding to the media content data from the template factory server 200, and generates a transaction defining the media content token. The transaction module 115 provides the generated transaction to the authentication module 117.

The authentication module 117, which is a decentralized identity (DID) module, receives a transaction from the transaction module 115, attaches an electronic signature to the transaction, and provides a result of this to the network request module 119. Herein, the authentication module 117 may use a private key to verify the validity of a transaction, and when the validity of the transaction is verified, the authentication module 117 generates an electronic signature and attaches the electronic signature to the transaction.

The network request module 119 issues the transaction to which an electronic signature is attached by the authentication module 117, to the blockchain network 300, and checks whether the transaction to which the electronic signature is attached is issued to the blockchain network 300 successfully.

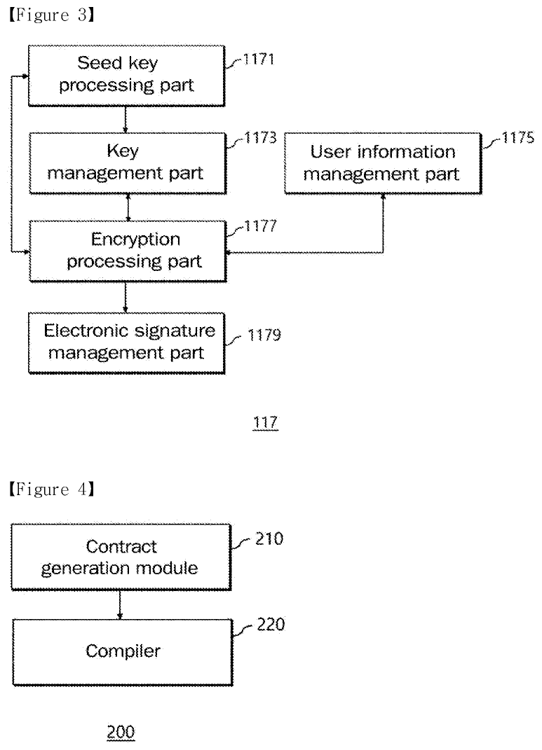

FIG. 3 is a block diagram illustrating a detailed configuration of the authentication module shown in FIG. 2.

Referring to FIG. 3, according to an embodiment of the present disclosure, the authentication module 117 may include a seed key processing part 1171, a key management part 1173, a user information management part 1175, an encryption processing part 1177, and an electronic signature management part 1179. The seed key processing part 1171 generates a seed key by using a seed key rule algorithm. The seed key processing part 1171 may generate a seed key by using mnemonic dictionary data. The seed key processing part 1171 may include a mnemonic converter (not shown) that performs conversion between mnemonic dictionary data and a seed key.

The key management part 1173 generates a private key by using a seed key, and generates a public key and an electronic wallet address by using the private key. The key management part 1173 may manage a seed key encrypted in association with a key identifier, an electronic wallet address, and blockchain network information. Herein, the blockchain network information may include a network structure, for example, a node Uniform Resource Locator (URL) of a chain or Ethereum, and an application programming interface (API) key.

The user information management part 1175 may manage user information in association with a meta data identifier. Specifically, the user information management part 1175 may manage interface information, user information encrypted in association with a meta data identifier, and blockchain network information. Herein, the interface information may include an interface item, for example, a name, a phone number, and an e-mail address, for writing user information.

The encryption processing part 1177 may perform encryption on information managed by the seed key processing part 1171, the key management part 1173, and the user information management part 1175, and may perform decryption on the information managed by the seed key processing part 1171, the key management part 1173, and the user information management part 1175 to perform verification on the information. In addition, the encryption processing part 1177 may generate a function required to generate an electronic signature.

The electronic signature management part 1179 receives a transaction from the transaction module 115, and generates an electronic signature by verifying the validity of the transaction through the encryption processing part 1177.

The electronic signature management part 1179 may generate an electronic signature by using an electronic signature function generated by the encryption processing part 1177. In addition, the electronic signature management part 1179 may verify the validity of a transaction by using a private key. When the validity of the transaction is verified, the electronic signature management part 1179 attaches an electronic signature to the transaction and transmits a result of this to the network request module.

FIG. 4 is a block diagram illustrating a detailed configuration of the template factory server shown in FIG. 1.

Referring to FIG. 4, according to an embodiment of the present disclosure, the template factory server 200 may include a contract generation module 210 and a compiler 220. When the contract generation module 210 receives a contract generation request from the application 110, the contract generation module 210 uses the pre-registered standard contract template to generate a user contract template corresponding to media content data.

To this end, the contract generation module 210 may include a standard contract template provider 212, a meta data constructor 214, and a user contract template generator 216. Herein, the standard contract template provider 212 provides at least one pre-written standard contract template.

The meta data constructor 214 generates an interface rule for each media content data. Herein, the interface rule may be a rule for setting an interface to be included in a user contract template for each media content data. For example, the interface may include items for writing the owner of the user terminal 100, media content data, and execution conditions (a penalty and a transaction fee) associated with the issuance of the media content data. An embodiment of the present disclosure is not limited thereto. When the owner of the user terminal 100 is different from the writer of the media content data, the interface may include an item for writing the writer of the media content data.

When the contract generation request is received, the user contract template generator 216 selects the standard contract template corresponding to the media content data, and generates a user contract template by changing the part to be included in or excluded from the program code of the standard contract template according to the interface rule. The user contract template generator 216 provides the generated user contract template to the compiler 220.

The compiler 220 complies the user contract template to generate bytecode, and provides the bytecode to the application 110 as a user contract code.

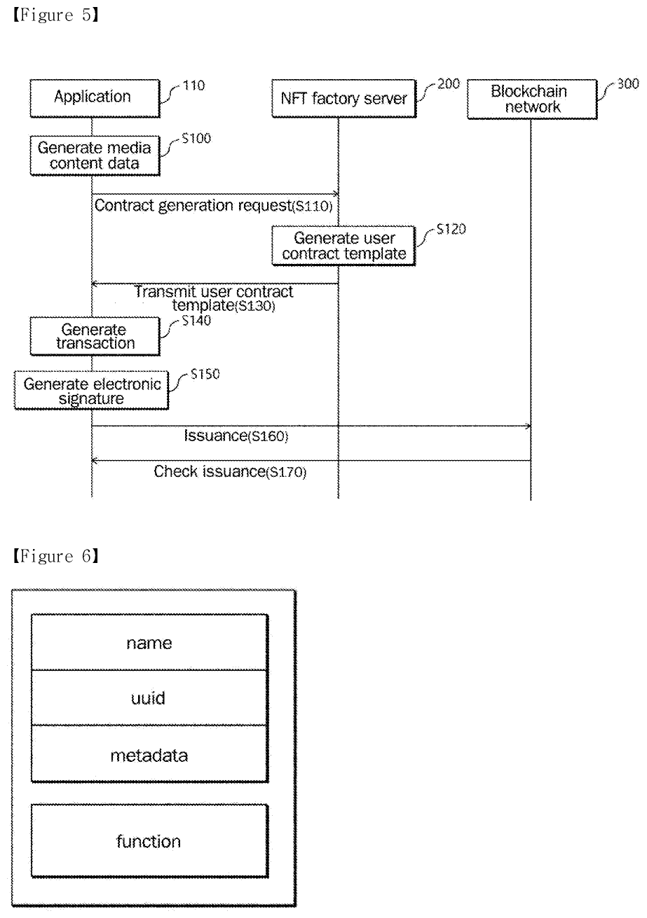

FIG. 5 is a diagram illustrating a method for providing a service of issuing a media content token according to an embodiment of the present disclosure. FIG. 6 is a diagram illustrating a configuration of a user contract template according to an embodiment of the present disclosure.

In FIG. 5, first, the media content generation module 111 generates media content data at step S100. Herein, the media content data may include at least one selected from a group of image data, video data, and audio data that are generated by the function of the camera or the recorder.

Next, the preprocessing module 113 performs preprocessing on the media content data and provides a result of preprocessing to the transaction module 115. Next, when the transaction module 115 receives the media content data subjected to preprocessing, the transaction module 115 transmits a contract generation request to the template factory server 200 at step S110. Herein, when making the contract generation request, the transaction module 115 may provide the template factory server 200 with information on the format of the media content data. An embodiment of the present disclosure is not limited thereto. When making the contract generation request, the transaction module 115 may provide the template factory server 200 with information on a request of the user who has produced the media content data.

When receiving the contract generation request, the template factory server 200 generates a user contract template through the contract generation module 210 at step S120, and transmits the user contract template to the transaction module 115 at step S130. Herein, the contract generation module 210 may select the standard contract template corresponding to the format of the media content data among the one or more pre-stored standard contract templates, and may change the program code of the standard contract template according to the interface rule corresponding to the standard contract template to generate the user contract template.

For example, as shown in FIG. 6, the contract generation module 210 may generate the user contract template including a name (name), a discriminator (uuid), information (metadata), and a function (function) of the media content token. Herein, the information of the media content token, that is, the metadata may include the interface selected according to the interface rule. For example, the metadata may include an interface for writing information on the user who owns the user terminal 100, media content data, and execution conditions (a penalty and a transaction fee) associated with the issuance of the media content data. An embodiment of the present disclosure is not limited thereto. When the user who owns the user terminal 100 is different from the user who has produced the media content data, the metadata may include the interface for writing information on the user who has produced the media content data. In addition, the functions of the media content token match the functions defined by generated respective transactions, and may include a function for checking information on the media content token, for example, information on the owner or issuer, or for transmitting or deleting the media content token.

Next, the transaction module 115 generates a transaction on the basis of the user contract template at step S140. That is, the transaction module 115 may write the details corresponding to the interface of the user contract template shown in FIG. 6. For example, the transaction module 115 may generate a transaction by writing, in the user contract template, the electronic wallet address corresponding to the user who has produced the media content data, the electronic wallet address corresponding to the user who owns the user terminal 100, the metadata corresponding to the media content token, and the execution conditions associated with the issuance of the media content data.

Herein, when the metadata of the media content token is image data, raw image binary data and an image thumbnail are included or an image URL is included according to the performance of the blockchain network 300. For example, when the blockchain network 300 has a chain structure, the metadata of the media content token may include raw image binary data and an image thumbnail. When the blockchain network 300 has an Ethereum structure, an image URL may be included.

In addition, when the image data is image data resulting from splitting, the metadata of the media content token may be constructed in association with a metadata ID. Herein, the metadata may include raw image binary data or an image thumbnail, image resolution, an image extension, and image data resulting from splitting. The image data resulting from splitting may include a split data ID and information on the order of splitting.

Next, the transaction module 115 transmits the generated transaction to the authentication module 117. Then, the authentication module 117 uses a private key to verify the validity of the transaction and generates an electronic signature when the validity of the transaction is verified, at step S150. The authentication module 117 attaches the generated electronic signature to the transaction and transmits the transaction to the network request module 119.

Next, the network request module 119 registers and stores the transaction to which the electronic signature is attached, in the blockchain network 300 by the input user command. That is, the transaction to which the electronic signature is attached is issued to the blockchain network 300 at step S160. Herein, the network request module 119 checks the balance in the electronic wallet and the issuance fee of the transaction from the blockchain network 300 and displays the same through the user terminal 100. The network request module 119 may receive the user command by obtaining the approval for issuance of the transaction from the user terminal 100. That is, the user may select whether to issue a transaction considering the balance in the electronic wallet.

When the transaction to which the electronic signature is attached is issued to the blockchain network 300, the network request module 119 checks whether the transaction is issued to the blockchain network 300 successfully at step S170. When the transaction to which the electronic signature is attached is issued to the blockchain network 300 successfully, the network request module 119 displays an issuance success message through the user terminal 100. The transaction issued to the blockchain network 300 may be propagated to the plurality of nodes, and the issuance fee may be paid within the balance in the electronic wallet. In addition, when the transaction is transacted, a fee according to the execution condition included in the transaction is received or paid As described above, in an embodiment of the present disclosure, when media content data is generated through the application 110, a user contract template corresponding to the media content data is received from the template factory server 200, and a transaction suitable for a smart contract is automatically generated and is issued to the blockchain network 300 in real time. Accordingly, as soon as the writer of the media content data produces the media content data through the application 110, the media content token is issued to the blockchain network 300, so that uniqueness of the copyright on the media content data can be ensured.

1. An apparatus for providing a service of issuing a media content token, the apparatus comprising:
an application installed in a user terminal, and configured to generate media content data, receive a user contract template corresponding to the media content data from a template factory server, generate a media content token, add an electronic signature to the media content token, and issue the media content token to which the electronic signature is added, to a blockchain network; and
the template factory server configured to generate the user contract template corresponding to the media content data on the basis of a pre-stored standard contract template.

2. The apparatus of claim 1, wherein the application comprises:
a media content generation module configured to generate the media content data;
a transaction module configured to receive the user contract template from the template factory server and generate a transaction that defines the media content token;
an authentication module configured to verify the transaction to generate the electronic signature; and
a network request module configured to issue a transaction to which the electronic signature is attached, to the blockchain network.

3. The apparatus of claim 2, wherein the media content generation module is configured to execute a camera or a recorder to generate at least one selected from a group of image data, video data, and audio data, as the media content data.

4. The apparatus of claim 2, wherein the transaction module is configured to transmit a contract generation request corresponding to a format of the media content data to the template factory server when the media content data is generated, and write the user contract template provided by the contract generation request to generate the transaction.

5. The apparatus of claim 4, wherein the one or more standard contract templates according to the formats of the media content data are pre-stored in the template factory server, and the template factory server is configured to select any one of the standard contract templates according to the contract generation request, and change the selected standard contract template according to a preset interface rule to generate the user contract template.

6. The apparatus of claim 5, wherein the interface rule is a rule for selecting at least one piece of meta data of the media content data.

7. The apparatus of claim 2, wherein the authentication module is configured to verify the transaction by using a private key.

8. The apparatus of claim 2, wherein the application further comprises a preprocessing module configured to perform preprocessing on the media content data into a preset data structure.

9. The apparatus of claim 8, wherein the preprocessing module is configured to perform preprocessing on the media content data into a preset capacity and a preset extension.

10. A method for providing a service of issuing a media content token, the method comprising:
generating, by an application, media content data;
generating, on the basis of a pre-stored standard contract template by a template factory server, a user contract template corresponding to the media content data; and
receiving, by the application, the user contract template, generating a media content token, adding an electronic signature to the media content token, and issuing the media content token to which the electronic signature is added, to a blockchain network.

11. The method of claim 10, wherein the generating of the media content data comprises executing, by a media content generation module, a camera or a recorder to generate at least one selected from a group of image data, video data, and audio data, as the media content data.

12. The method of claim 10, wherein the generating of the user contract template comprises:
storing the one or more standard contract templates according to the formats of the media content data;
selecting any one corresponding to the format of the media content data generated by the application among the stored one or more standard contract templates; and
changing the selected standard contract template according to a preset interface rule.

13. The method of claim 12, wherein the interface rule is a rule for selecting at least one piece of meta data of the media content data.

14. The method of claim 10, wherein the issuing of the media content token comprises:
writing, by a transaction module, the user contract template to generate a transaction that defines the media content token;
verifying, by an authentication module, the transaction to generate the electronic signature; and
registering and storing, by a network request module, a transaction to which the electronic signature is added, in the blockchain network.

15. The method of claim 10, further comprising performing, by a preprocessing module, preprocessing on the generated media content data into a preset data structure.

16. The method of claim 15, wherein the performing of the preprocessing comprises changing the generated media content data into a preset capacity and a preset extension.
